(19) United States
(12) Patent Application Publication
(10) Pub. No.: US 2013/0064246 A1
(43) Pub. Date: Mar. 14, 2013

(54) Packet Forwarding Using an Approximate Ingress Table and an Exact Egress Table

(71) Applicants: Sarang Dharmapurikar, Santa Clara, CA (US); Kit Chiu Chu, Fremont, CA (US); Mahesh Maddury, San Jose, CA (US); Dinesh G. Dutt, Sunnyvale, CA (US); Francisco Matus, Saratoga, CA (US)

(72) Inventors: Sarang Dharmapurikar, Santa Clara, CA (US); Kit Chiu Chu, Fremont, CA (US); Mahesh Maddury, San Jose, CA (US); Dinesh G. Dutt, Sunnyvale, CA (US); Francisco Matus, Saratoga, CA (US)

(73) Assignee: CISCO TECHNOLOGY, INC., San Jose, CA (US)

(21) Appl. No.: 13/229,894

(22) Filed: Sep. 12, 2011

(51) Int. Cl. H04L 12/56

(52) U.S. Cl. 370/392; 370/401

(57) ABSTRACT

Techniques are provided for forwarding packets via an intermediate network device. A packet comprising a destination MAC address is received at a first port of a network device having a plurality of bi-directional ports. A second port of the network device to which the packet should be forwarded is identified through the use of at least an approximate ingress table at the first port comprising a plurality of compressed destination MAC addresses each having an associated egress port, and the packet is forwarded to the second port. At the second port, a subsequent network device to which the packet should be forwarded is identified through the use of an exact egress table at the second port including exact destination MAC addresses each associated with a network device connected to the second port, and the packet is forwarded to the subsequent network device.

### TECHNICAL FIELD

The present disclosure relates to forwarding packets in a network device.

### BACKGROUND

In a packet-switched or packet mode computer network, data is transmitted in the form of packets (sometimes referred to as datagrams, segments, blocks, cells or frames) according to predefined protocols, such as the Transmission Control Protocol/Internet Protocol (TCP/IP). A sequence of packets transmitted from a source device to a destination device is referred to as a network flow.

Packets generally comprise control information and actual data (also known as payload). The control information is data that intermediate network devices (e.g., switches, routers, etc.) use to forward the packet from the source device to the destination device. The control information may comprise, for example, source and destination addresses (e.g., source and destination Media Access Control (MAC) addresses), error detection codes (i.e., checksums), sequencing information, etc. This control information is generally found in a portion of the packet referred to as the packet header (i.e., the information that precedes the actual data within the packet) and/or the packet trailer (i.e., the information that follows the actual data within the packet).

### BRIEF DESCRIPTION OF THE DRAWINGS

FIG. 1 is a block diagram of an example packet switching computer network having network devices configured to forward packets using approximate ingress tables and exact egress exact tables.

FIG. 2 is a block diagram of an example network device configured to forward packets using the approximate ingress tables and the exact egress tables.

FIGS. 3A, 3B and 3C are examples of approximate, exact and correction tables, respectively, used by network devices to forward packets in accordance with example techniques described herein.

FIG. 4 is a high level flowchart of an example method for forwarding a packet using the approximate ingress tables and the exact egress tables.

FIG. 5 is a detailed flowchart of an example method implemented at an ingress port of a network device to forward a packet to an egress port using the approximate ingress table.

FIG. 6 is a detailed flowchart of an example method implemented at an egress port of a network device to forward a packet to a subsequent network device using the exact egress table.

FIG. 7 is a flowchart of an example method for updating forwarding tables at an ingress port.

### DESCRIPTION OF EXAMPLE EMBODIMENTS

Overview

Techniques are provided for forwarding packets via an intermediate network device. A packet comprising a destination MAC address is received at a first port of a network device having a plurality of bi-directional ports. A second port of the network device to which the packet should be forwarded is identified through the use of at least an approximate ingress table at the first port comprising a plurality of compressed destination MAC addresses each having an associated egress port, and the packet is forwarded to the second port. At the second port, a subsequent network device to which the packet should be forwarded is identified through the use of an exact egress table at the second port including exact destination MAC addresses each associated with a network device connected to the second port, and the packet is forwarded to the subsequent network device.

Example Embodiments

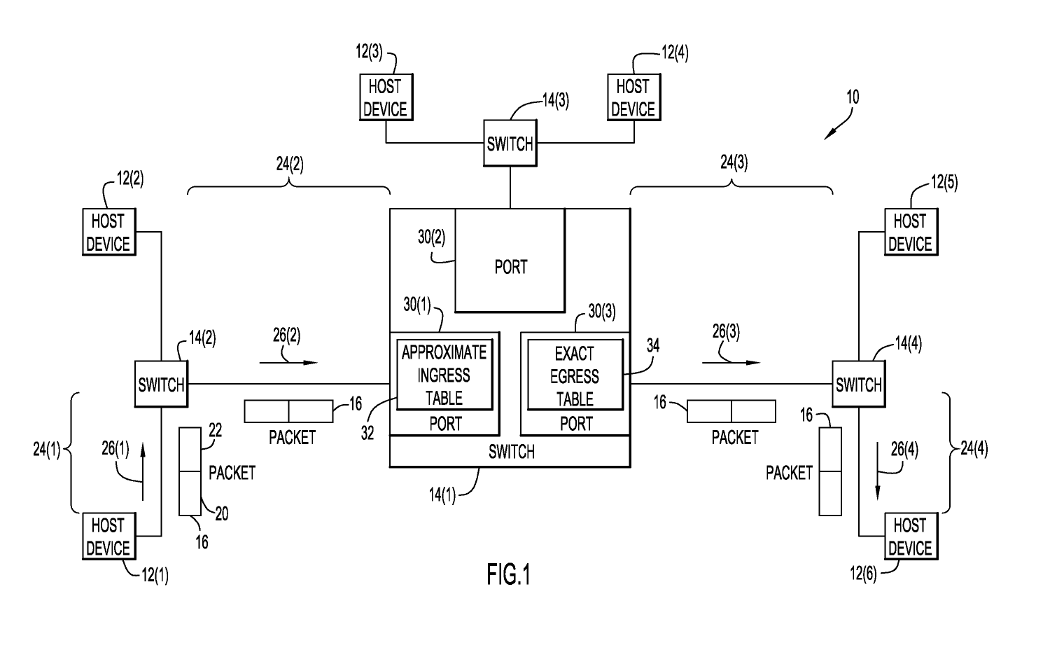

FIG. 1 is a block diagram of a packet switching computer network 10. As shown, network 10 comprises a plurality of host devices 12(1)-12(6) and a plurality of switches 14(1)-14(4). In this example, network 10 is an Ethernet local area network (LAN).

A computer network is a communication system that links two or more computers or other network devices so that the network devices may communicate, share resources, access centrally stored information, etc. In a packet-switched network, such communication occurs through the exchange of packets. In the example of FIG. 1, host devices 12(1)-12(6) are network devices, such as computers, servers, peripheral devices, etc., that may be either a source network device (i.e., a network device that sends a packet) or a destination network device (i.e., a device that receives a packet generated by a source device). Packets are transferred (routed) from a source network device to a destination network device through the use of one or more intermediate network devices, such as switches 14(1)-14(4) of FIG. 1. In other words, switches 14(1)-14(4) are network devices that use a combination of hardware and/or software to direct packets through the network.

In the example of FIG. 1, a packet 16 is transmitted from host device 12(1) (source network device) to host device 12(6) (destination network device). During the transmission, packet 16 travels along several discrete segments 24(1)-24(4). Segment 24(1) is between host device 12(1) and switch 14(2), segment 24(2) is between switch 14(2) and switch 14(1), segment 24(3) is between switch 14(1) and switch 14(4), and segment 24(4) is between switch 14(4) and host device 12(6). The direction of packet 16 for each segment 24(1)-24(4) is shown by arrows 26(1)-26(4), respectively.

Packet 16 comprises control information 20 and actual data (payload) 22. The actual data 22 may comprise, for example, video data, numeric data, alphanumeric data, voice data, etc. The control information 20 comprises information that is used by switches 14(2), 14(1), and 14(3) to direct packet 16 along the segments to host device 12(6). Control information 20 may comprise, for example, source and destination addresses, error detection codes (i.e., checksums), sequencing information, etc. In an Ethernet network, the source/destination addresses in control information 20 are unique identifiers assigned to network interfaces of network devices, referred to as Media Access Control (MAC) addresses. As such, in the example of FIG. 1, control information 20 in packet 16 includes a source MAC address, which is the unique identifier for the network interface of host device 12(1), as well as a destination MAC address, which is the unique identifier for the network interface of host device 12(6). MAC addresses are formed according to the rules of one of three numbering name spaces managed by the Institute of Electrical and Electronics Engineers (IEEE) (e.g., the 48-bit MAC (MAC-48), the 48-bit Extended Unique Identifier (EUI-48), and the 64-bit Extended Unique Identifier (EUI-64)).

In a conventional packet switching network, a switch forwards a packet through the use of a central switching table. The central switching table includes entries comprising: (1) the exact MAC addresses for all host devices in the computer network, (2) the exact virtual local area network (VLAN) identifier, and (3) the associated interface identifier for the interface to be used to forward the packet. Generally, the MAC address has a length of 48 bits and the VLAN identifier has a length of 12 bits, leading to a 60-bit entry along with the associated interface identifier.

When a conventional switch receives a packet containing a destination MAC address that is absent from the central forwarding table, the packet is broadcast to every host device in the network (referred to as broadcast floods), thereby consuming valuable network bandwidth. As a result, designers have increased the size of the central forwarding table to accommodate as many entries as the number of hosts in the network to avoid broadcast floods. However, computer networks, particularly Ethernet networks, are configured to be very large and include a large number of host devices (e.g., in the order of several hundreds of thousands of host devices). This is particularly true given the advent of server virtualization in datacenters in which a single physical server can host multiple virtual servers each having its own MAC address. As such, in order to accommodate these large numbers of MAC addresses, the central forwarding table utilizes a large amount of memory (e.g., Random Access Memory (RAM)) in an application-specific integrated circuit (ASIC) on the switch.

Techniques are described herein for forwarding packets in such a way so as to substantially reduce the memory utilized by an intermediate network device (e.g., switch) to forward a packet by eliminating use of a central forwarding table containing the exact MAC addresses for all host devices in the computer network. In accordance with techniques described herein, a packet is forwarded by a switch through the use of an approximate ingress table and an exact egress table.

FIG. 1 schematically illustrates an example implementation in which switch 14(1) comprises an approximate ingress table 32 and an exact egress table 34. More specifically, switch 14(1) includes three bi-directional ports that are each configured to operate as an ingress port for receipt of packets, or an egress port for forwarding of packets. With reference to packet 16 of FIG. 1, port 30(1) is the ingress port and ports 30(2) and 30(3) are potential egress ports.

When packet 16 is received at port 30(1), port 30(1) determines which of ports 30(2) or 30(3) is the correct egress for the packet. Port 30(1) identifies the correct egress port through the use of approximate ingress table 32 that includes a plurality of approximate destination MAC addresses each having an associated egress port. Further details of the use of approximate ingress tables to forward packets are provided below.

In the example of FIG. 1, port 30(3) is selected as the egress port, and packet 16 is forwarded to this port. Port 30(3) then identifies the correct subsequent device to which packet 16 should be forwarded so that it reaches its final destination which, as noted above, is host device 12(6). This identification is performed through the use of exact egress table 34 that includes the exact destination MAC addresses for the only the host network devices that are associated with that port. In other words, egress table 34 only includes the MAC addresses for host devices that are connected, directly or indirectly to that port. In the example of FIG. 1, host devices 12(5) and 12(6) are indirectly connected to port 30(3) via switch 14(4) and, as such, exact egress table 34 includes the exact MAC addresses for these two network devices. Packet 16 is then forwarded to a subsequent network device. The subsequent network device may be the destination device or, as shown in FIG. 1, another intermediate network device, such as switch 14(4).

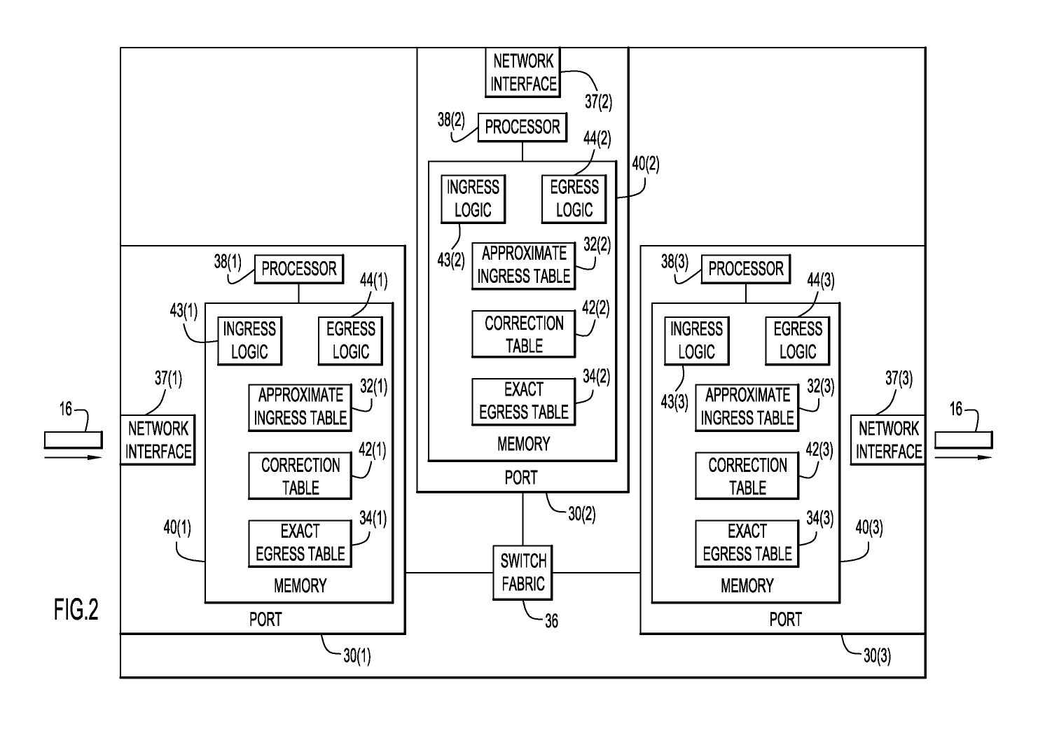

FIG. 2 is a block diagram illustrating further details of switch 14(1) of FIG. 1. Switch 14(1) comprises three ports 30(1)-30(3) and switch fabric 36. Each port 30(1)-30(3) comprises a network interface 37(1)-37(3), respectively, a processor 38(1)-38(3), respectively, and memory 40(1)-40(3), respectively. Each memory 40(1)-40(3) comprises an approximate ingress table 32(1)-32(3), respectively, a correction table 42(1)-42(3), respectively, and an exact egress table 34(1)-34(3), respectively. Each memory 40(1)-40(3) also comprises ingress logic 43(1)-43(3) and egress logic 44(1)-44(3)). It is to be appreciated that switches 14(2)-14(4) may include the same elements as switch 14(1), but, for simplicity, only switch 14(1) is described in detail herein.

In the example of FIG. 2, each of ports 30(1)-30(3) are implemented as separate ASICS configured to receive packets from, and forward packets to, other network devices. As such, ports 30(1)-30(3) are considered to be bi-directional and support both ingress and egress processing of packets described below. Additionally, the port ASICs of switch 14(1) are separate from the switch fabric 36.

In the example of FIG. 2, packet 16 is part of a network flow that is transmitted from a source network device (i.e., host device 12(1) of FIG. 1) to a destination device (i.e., host device 12(6) of FIG. 1). During the transmission, the network flow passes through one or more intermediate network devices, including switch 14(1). More specifically, packet 16 is received at port 30(1) via network interface 37(1) and the eventual destination network device for packet 16 is connected to the network interface of either port 30(2) or port 30(3). It is to be appreciated that the destination network device may be directly connected to one of network interfaces 37(2) or 37(3), or may be indirectly connected to the interface (i.e., through one or more other intermediate network devices).

In the example of FIG. 2, upon receipt of packet 16, processor 38(1) implements ingress logic 43(1) (i.e., ingress packet processing) to determine which of the ports 30(2) or 30(3) should be used to forward packet through to the eventual destination device. This ingress processing forwards the packet through the use of approximate ingress table 32(1) in memory 40(1).

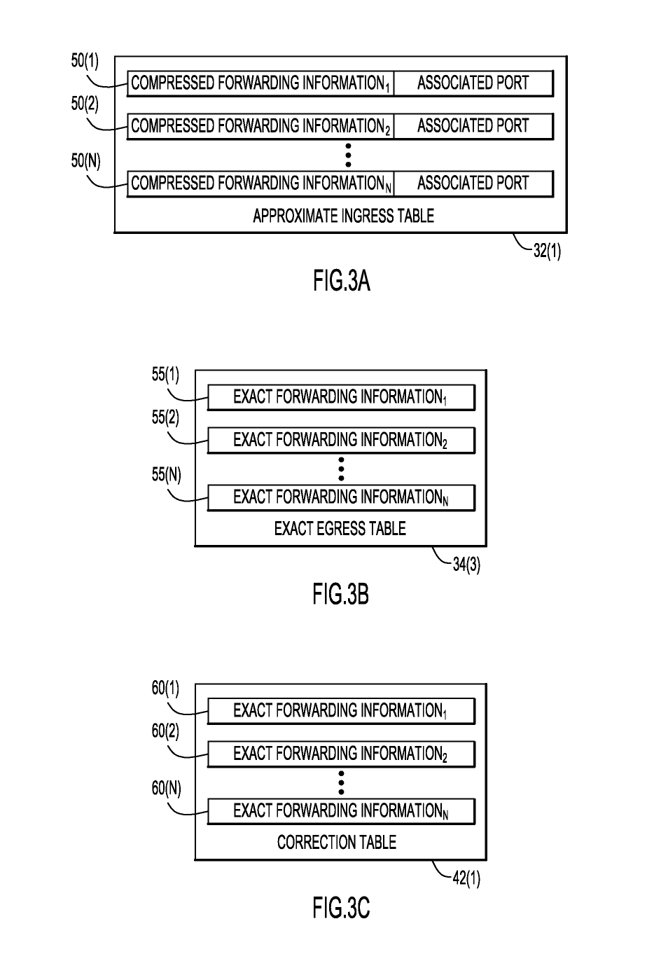

As shown in FIG. 3A, approximate ingress table 32(1) is a Layer 2 table that contains a plurality of approximate data structures 50(1)-50(N) (table entries) that each include compressed forwarding information used for forwarding packet 16. That is, in contrast to a conventional switch forwarding table that includes a 60-bit entry (i.e., 48 MAC address bits and 12 VLAN identifier bits), the information in table entries 50(1)-50(N) are compressed versions of the full conventional forwarding table entry. More specifically, a hash function is used to compress the forwarding information into a smaller number of bits.

The compressed forwarding information in each table entry 50(1)-50(N) includes a MAC address for a destination host device in computer network 10 and an associated VLAN identifier. The compressed forwarding information in each table entry 50(1)-50(N) also has an interface (port) associated therewith. In such an example, the size of the compressed forwarding information in each of table entries 50(1)-50(N) may be, for example, approximately 8 to 16 bits (assuming compressed forwarding information comprises the MAC address and VLAN identifier).

It is to be appreciated that the destination MAC addresses and the VLAN identifier are merely examples of the contents of compressed forwarding information in a table entry 50(1)-50(N) and that other control information may be additionally or alternatively be included in an entry.

As noted above, in the example of FIG. 2, the MAC address for the destination device of packet 16, referred to as the destination MAC address, is included in the control information 20 of the packet. In operation, when packet 16 is received by port 30(1), processor 38(1) uses a hash function to convert the destination MAC address and, optionally, other control information, in packet 16 into a hash value. This hash value is compared to the entries 50(1)-50(N) in approximate ingress table 32(1), using a single memory access, to identify compressed forwarding information that matches the hash value.

In certain circumstances, the hash value generated through the ingress processing based on control information 20 in packet 16 may not have a match stored in approximate ingress table 32(1). In such cases, packet 16 is broadcast to all the other ports (ports 30(2) and 30(3)) in switch 14(1). Each port then uses the egress processing described below to determine if the destination device is connected to that port and, if so, to forward the packet. If the destination device identified in packet 16 is not connected to an egress port 30(2) or 30(3), the egress port may ignore the packet and send a correction notification to port 30(1), as described below.

In the example of FIG. 2, it is determined that the hash value generated based on the destination MAC address in packet 16 matches an entry having compressed forwarding information associated with port 30(3). As such, packet 16 is forwarded to port 30(3) via switch fabric 36. As a result of the use of the compressed forwarding information in approximate ingress table 32(1), there is a potential for forwarding of packets to an incorrect egress port. For example, incorrect forwarding may occur because two different MAC address/VLAN identifier pairs can produce the same compressed information, thereby resulting in collisions. This erroneous forwarding is corrected though the implementation of egress processing at a port following receipt of a forwarded packet.

In the example of FIG. 2, processor 38(3) is configured to implement egress logic 44(3) (i.e., egress processing) to forwards packet 16 through the use of exact egress table 34(3) in memory 40(3). As shown in FIG. 3B, exact egress table 34(3) is a Layer 2 table that includes a plurality of data structures (tables entries) 55(1)-55(N) that each include exact forwarding information used for forwarding packet 16 (e.g., 48 MAC address bits and 12 VLAN identifier bits). However, because table 34(3) is on the egress side of switch 14(1), the table only includes entries corresponding to the host network devices directly or indirectly connected to port 30(3). Stated another way, exact egress table 34(3) only includes the exact forwarding information for a subset of the host devices in computer network 10, and that subset corresponds to the host devices that are behind (connected to) that port. As noted above with reference to FIG. 1, port 30(3) is connected to host devices 12(5) and 12(6) via switch 14(4). As such, exact egress table 34(3) only includes the exact forwarding information for host devices 12(5) and 12(6).

In operation, when packet 16 is received by port 30(3) from port 30(1), processor 38(3) compares the destination MAC address in packet 16 to the exact forwarding information in table entries 55(1)-55(N) in exact egress table 34(3). The comparison, which uses a single memory access, identifies the network device attached to port 30(3) to which packet 16 should be forwarded. Subsequently, packet 16 is forwarded via network interface 37(3) to a subsequent network device. The subsequent network device may be the destination host device (direct connection) or, as shown in FIG. 2, the subsequent network device is an intermediate network device that is directly or indirectly connected to the destination device.

When packet 16 is received by port 30(3) and the MAC address and, optionally, other control information contained therein is compared to the entries in exact egress table 34(3), there are two potential results. First, as noted above, the egress processing may determine that the control information in packet 16 matches the exact forwarding information contained in one of the entries 55(1)-55(N), and packet 16 is forwarded, directly or indirectly, to the identified destination device. Second, the egress processing may determine that the control information in packet 16 does not match any of the exact forwarding information contained in one of the entries 55(1)-55(N). As noted above, in such circumstances, packet 16 was incorrectly forwarded to the port because the hash value computed based on the control information in the packet erroneously matched the compressed forwarding information for another destination device. This results from, for example, aliasing in computing the compressed forwarding information.

In such circumstances, because the egress processing has now looked up the exact forwarding information for packet 16 in exact egress table 34(3), the egress processing can trigger a correction process that prevents future incorrect forwarding of packets directed towards the destination device specified in packet 16. Further details of this correction process are provided below. However, one effect of this correction process is the transmission of a notification to port 30(1) that the port sent packet 16 to the wrong egress port. Port 30(1) is configured to maintain a correction table 42(1) that includes the exact forwarding information (i.e., destination addresses) in received packets that will result in forwarding of packets to the wrong egress port. Specifically, as shown in FIG. 3C, correction table 42(1) may include a plurality of entries 60(1)-60(N) each containing the exact forwarding information for destination devices that are likely to result in erroneous matches in approximate ingress table 32(1). As such, when packet 16 is received by port 30(1), the control information in the packet is first compared to the entries in correction table 42(1). If the control information in packet 16 matches an entry 60(1)-60(N) in the correction table 42(1), the packet is forwarded to the port associated with that entry. If no match is found in correction table 42(1), ingress processing uses approximate ingress table 32(1), as described above, to forward the packet to the correct egress port.

As noted above, each of ports 30(1)-30(3) are bi-directional and include an approximate ingress table 32(1)-32(3) respectively, an exact egress table 34(1)-34(3), respectively, and a correction table 42(1)-42(3), respectively. The entries in each of these tables include a Layer 2 address (source address and/or destination address) and/or other control information. It is to be appreciated that the techniques described herein are not limited to any specific types of control information in the table entries.

As noted above, FIG. 2 illustrates an example in which each of ports 30(1)-30(3) are implemented as separate ASICS each configured to perform ingress and egress operations. It is to be appreciated that in other examples each of ports 30(1)-30(3) may be implemented using multiple ASICS that, in one example, each perform the ingress or egress operations detailed above. Alternatively, multiple ports may be implemented in a single ASIC.

As noted above, the ingress and egress processing logic and the approximate, correction, and exact tables are stored in memory 40(1)-40(3). Each memory 40(1)-40(3) may comprise read only memory (ROM), random access memory (RAM), magnetic disk storage media devices, optical storage media devices, flash memory devices, electrical, optical, or other physical/tangible memory storage devices. The processors 38(1)-38(3) are, for example, microprocessors or microcontrollers that each execute instructions for the process logic 43(1)-43(3) and 44(1)-44(3) stored in memory 40(1)-40(3), respectively. Thus, in general, the memory 40(1)-40(3) may each comprise one or more computer readable storage media (e.g., a memory device) encoded with software comprising computer executable instructions and when the software is executed (by the processors 38(1)-38(3) it is operable to perform the operations described herein in connection with ingress logic 43(1)-43(3) and egress logic 44(1)-44(3).

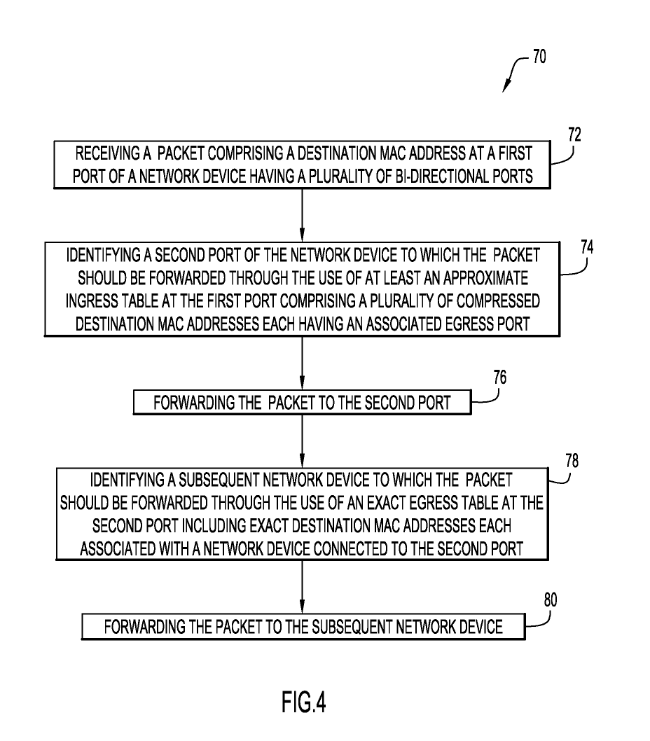

FIG. 4 is a flowchart of a method 70 for forwarding a packet through an intermediate network device, such as a switch. Method 70 begins at 72 where a packet is received at first port of a network device having a plurality of bi-directional ports. The packet comprises actual data and control information, which includes, among other information, a destination MAC address. The destination MAC address is the address of the destination device to which the packet should be forwarded. After receipt of the packet, at 74 the ingress processing in the first port identifies a second port of the network device to which the packet should be forwarded so that the packet can reach its destination. The ingress processing identifies the second port through the use of at least an approximate ingress table at the first port comprising a plurality of compressed destination MAC addresses each having an associated egress port. At 76, the packet is forwarded to the second port.

After the packet is received by the second port, at 78 the egress processing in the second port identifies a subsequent network device to which the packet should be forwarded. The egress processing identifies the subsequent network device through the use of an exact egress table at the second port including exact destination MAC addresses each associated with a network device connected to the second port. At 78, the packet is forwarded to the subsequent network device identified by the egress processing.

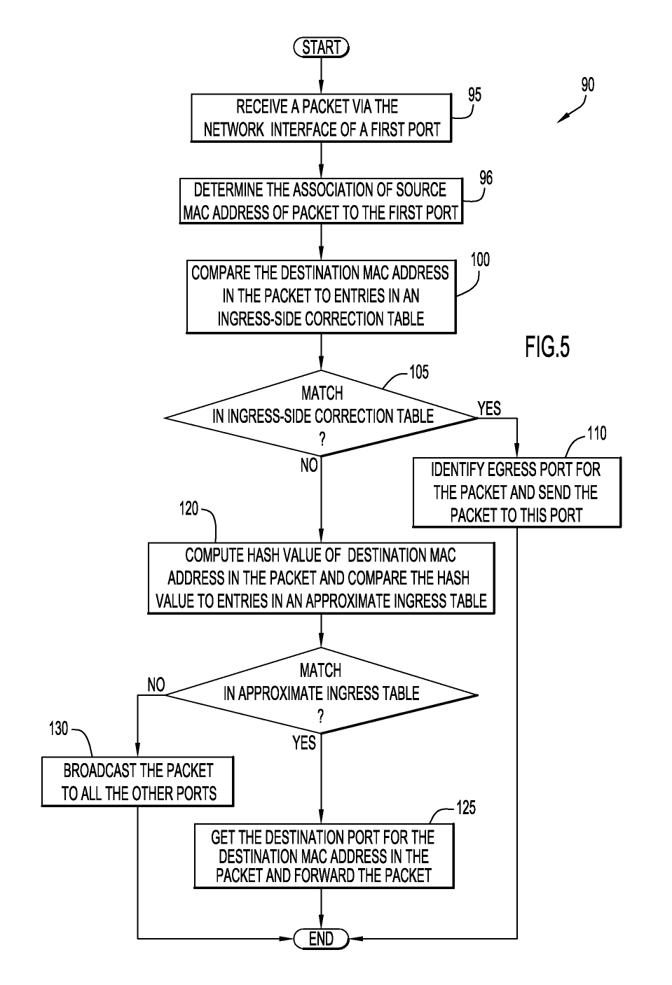

FIG. 5 is a detailed flowchart of an example method 90 for processing a packet at an ingress port of a switch. For ease of illustration, the example of FIG. 5 will be described with reference to the elements of switch 14(1) of FIG. 2 and the tables of FIGS. 3A-3C. It is to be appreciated that the order of the operations of method 90 presented below is merely illustrative and that, in other examples, the order of the following operations may be different.

At 95, packet 16 is received via network interface 37(1) of port 30(1). At 96, the association of the source MAC address of the received packet 16 to port 30(1) is determined. That is, a check is performed to determine if the source MAC address of packet 16 is already present in the ingress-side correction table. If the source MAC address is not present, the source MAC address is added to the ingress-side correction table and the source MAC address is associated with the port identifier of port 30(1).

At 100, at least a portion of the control information 20, particularly the destination MAC address, in packet 16 is compared to the entries 60(1)-60(N) in ingress-side correction table 42(1). At 105, a determination is made as to whether the destination MAC address in packet 16 matches the exact forwarding information in any of the entries 60(1)-60(N). If the destination MAC address in packet 16 matches the exact forwarding information in any of the entries 60(1)-60(N), method 90 proceeds to 110. At 110, using the destination MAC address, the egress port for the packet 16 is identified, the packet is forwarded to this port, and method 90 ends.

If the destination MAC address in packet 16 does not match the exact forwarding information in any of the entries 60(1)-60(N), method 90 proceeds to 115. At 115, a hash function is used to compute a hash value of the destination MAC address (and optionally other control information) in packet 16. The hash value is then compared to the entries 50(1)-50(N) in approximate ingress table 32(1). At 120, a determination is made as to whether the hash value matches the compressed forwarding information in any of entries 50(1)-50(N). If the computed hash value matches the compressed forwarding information in any of the entries 50(1)-50(N), method 90 proceeds to 125. At 125, using the port associated with the matching compressed forwarding information, the egress port for the packet 16 is identified, the packet is forwarded to this port, and method 90 ends.

If the computed hash value does not match the compressed forwarding information in any of entries 50(1)-50(N), method 90 proceeds to 130. At 130, packet 16 is broadcast to all other ports in switch 14(1) (i.e., ports 30(2) and 30(3)), and method 90 ends.

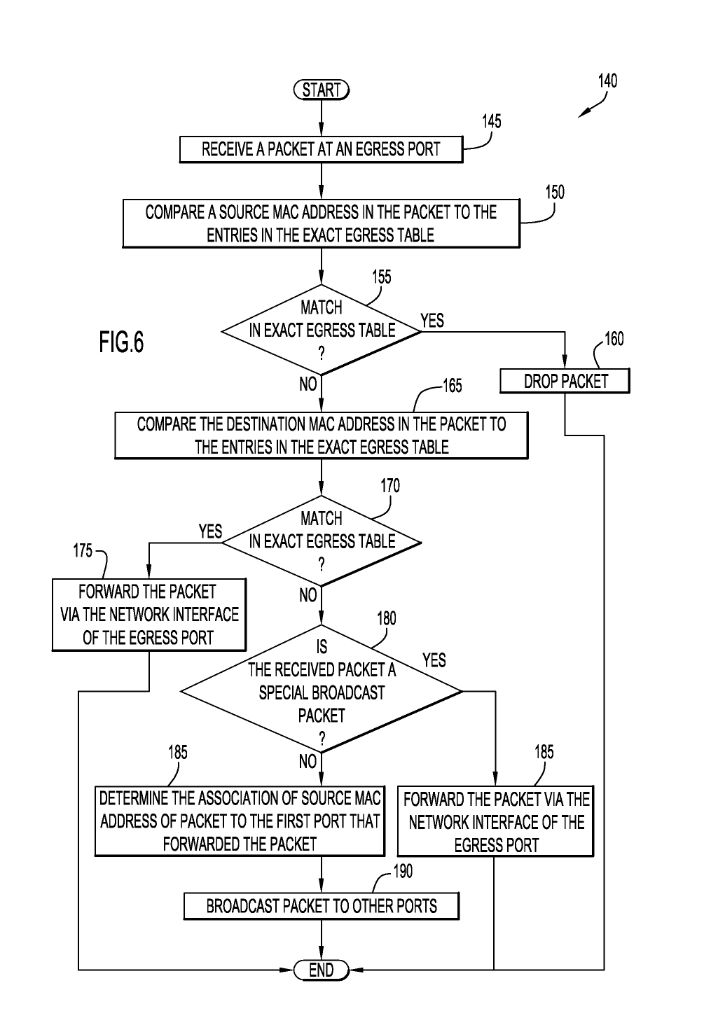

FIG. 6 is a detailed flowchart of an example method 140 for processing a packet forwarded to an egress port of a switch. For ease of illustration, the example of FIG. 6 will be described with reference to the elements of switch 14(1) of FIG. 2 and the tables of FIGS. 3A-3C. It is to be appreciated that the order of the operations of method 140 presented below is merely illustrative and that, in other examples, the order of the following operations may be different.

At 145, packet 16 is received at port 30(3). As noted above, packets, such as packet 16, include control information. This control information may comprise a destination MAC address as well as a source MAC address. At 150, the source MAC address in packet 16 is compared to the entries 55(1)-55(N) in exact egress table 34(3). At 155, a determination is made as to whether the source MAC address matches the exact forwarding information in any of entries 55(1)-55(N). If a match is found, the egress processing determines that packet 16 was sourced by port 30(3) and is erroneously looping back. As such, method 140 proceeds to 160 where packet 16 is dropped and method 140 ends.

If, at 155, a match between the source MAC address and the forwarding information in any of entries 55(1)-55(N) is not found, method 140 proceeds to 165. At 165, the destination MAC address in packet 16 is compared to entries 55(1)-55(N) in exact egress table 34(3). At 170, a determination is made as to whether the destination MAC address matches the exact forwarding information in any of entries 55(1)-55(N). If a match is found, method 140 proceeds to 175 where packet 16 is forwarded, via network interface 37(3), to the network device identified in the matching entry 55(1)-55(N) and method 140 ends.

If, at 170, a match between the destination MAC address in packet 16 and the exact forwarding information in entries 55(1)-55(N) is not found, method 140 proceeds to 180. At 180, a determination is made as to whether packet 16 is a special broadcast/special flood packet (i.e., whether packet 16 was received at port 30(3) as a result of a broadcast). This determination is made based on a bit in control information 20 of packet 16 referred to herein as the special broadcast or special flood bit. If the special broadcast bit is set, packet 16 is determined to be a broadcast packet. As such, another flood is not used and method 140 proceeds to 185 where the packet 16 is forwarded on this port.

Alternatively, if the special broadcast bit is not set, then packet 16 is determined to be a regular packet that was received from another port (i.e., the packet was not broadcast to all ports). In other words, if packet 16 is not a special broadcast packet, then the packet came from an original ingress port and not a proxy port that set the special flood bit and sent the packet to all ports. If packet 16 is a regular packet (i.e., not a special flood packet), then, at 186, the association of the source address of the packet to the ingress port from where it was sourced is determined. That is, a check is performed to determine if the compressed source address is present in the port's approximate ingress table. If it is not present, the address is inserted and the source port (ingress port which sent the packet) is associated with the address.

At 190, a special broadcast is performed to flood all ports with the packet. Operations that occur subsequent to such a flood are described below.

As noted above, in certain circumstances, an egress port, such as port 30(3), can perform a special broadcast of a packet when the packet was erroneously received by the port. To perform a special broadcast, a bit in the control information of the packet (i.e., the special broadcast bit) is set and the packet is forwarded to all the ports (including itself). When all the ports receive this special broadcast packet, if the intended destination host device is connected to a port, the corresponding port will understand that another port is trying to reach it, but has wrong information in its approximate ingress table (i.e., due to aliasing). With this knowledge, the correct egress port can now inform the ingress port that if it wants to reach the host device identified in the special broadcast packet, it should send the packet to that port. This correction notification is sent via a special control message or through the supervisor software. Once the ingress port learns of the correct port for packets having the specific destination MAC address, the destination MAC address is added to the ingress correction table.

Special broadcasts may also advantageously prevent looping of a packet. When a packet is broadcasted by a port, it is received by the ingress port that forwarded the packet. However as noted in FIG. 6, because it is a special broadcast, the ingress port looks up the source address of this packet in its exact table and understands that the packet originated from it. The packet is then dropped by the ingress port.

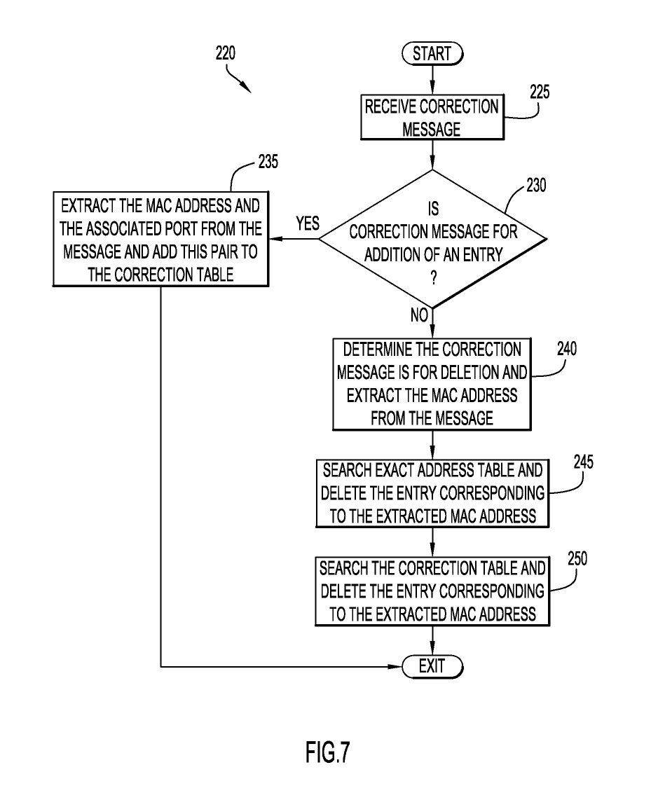

If a certain MAC address is removed from the exact egress table on an egress port (e.g., when a network device is disconnected from the egress port), the egress port notifies all the other ports of this removal (via a correction message) so that they can remove the same entry from their respective correction tables as well as approximate ingress tables. Similarly, such correction messages may be used to add entries, as noted above, to the correction tables and the approximate ingress tables (i.e., when a new network device is connected to an egress port). FIG. 7 is a flowchart of a method 220 for updating ingress forwarding tables.

At 225 a correction message, as noted above, is received at the ingress port. At 230, a determination is made as to whether the correction message is for the addition of an entry to the correction table. If the correction message is for addition of an entry, method 220 proceeds to 235 where the MAC address and the associated port are extracted from the correction message and this pair is added to the correction table.

If, at 230, it is determined that the correction message is not for addition of an entry (i.e., the correction message is for deletion), then method 220 proceeds to 240 where the MAC address is extracted from the message. At 245, a search is conducted in the correction table for an entry corresponding to the extracted MAC address, and this corresponding entry is deleted from the correction table. At 250, a search is conducted in the approximate ingress table for an entry corresponding to the extracted MAC address, and this corresponding entry is deleted from the approximate ingress table.

As noted above, one advantage of the packet forwarding techniques described herein is reduced memory utilization (when compared to conventional techniques using a centralized forwarding table containing the exact MAC addresses of all network devices in the computer network). More particularly, the combination of an approximate ingress table and an exact egress table may achieve correct forwarding with only about 15% to 25% of the memory utilized in conventional techniques. The memory utilized to forward packets using an approximate ingress table and an exact egress table may determined as described below, where:
k: the width of the look up key in the forwarding table
d: the width of the forwarding information associated with each key
n: total number of hosts in the system
c: compression ratio for the key, c<1
p: number of ports in the switch
h: number of port ASICs. This is different from the number of ports because typically multiple ports are aggregated within a single chip.

In a traditional system the forwarding tables on a chip would consume the amount of memory given below by Equation (1).

T=n(k+d)bits Equation (1)

Using techniques described herein, the approximate ingress table on a chip would consume the amount of memory given below by Equation (2), and the exact egress table would consume the amount of memory given below by Equation (3).

A=n(ck+ceiling(log₂[p]) bits Equation (2)

E=[n(k+d)]/h bits Equation (3)

As such, the total memory consumed in accordance with certain techniques described herein may be given below by Equation (4).

T=A+E=n(ck+ceiling(log₂[p])[n(k+d)]/h bits Equation (4)

Therefore, the memory savings is given below by Equation (5).

S=[1−(A+E)/T]×100%={1−[(ck+ceiling(log₂[p]))/(k+d)+1/h]}×100% Equation (5)

The above description is intended by way of example only.

What is claimed is:

1. A method comprising:
receiving a packet comprising a destination MAC address at a first port of a network device having a plurality of bi-directional ports;
identifying a second port of the network device to which the packet should be forwarded through the use of at least an approximate ingress table at the first port comprising a plurality of compressed destination MAC addresses each having an associated egress port;
forwarding the packet to the second port;
identifying a subsequent network device to which the packet should be forwarded through the use of an exact egress table at the second port including exact destination MAC addresses each associated with a network device connected to the second port; and
forwarding the packet to the subsequent network device.

2. The method of claim 1, wherein identifying a subsequent network device to which the received packet should be forwarded comprises:
comparing the destination MAC address in the packet to the exact destination MAC addresses in the exact egress table to identify a matching destination MAC address in the exact egress table.

3. The method of claim 1, wherein identifying a subsequent network device to which the packet should be forwarded comprises:
comparing the destination MAC address in the packet to the exact destination MAC addresses in the exact egress table;
determining that the destination MAC address in the packet does not match any destination MAC addresses in the exact egress table; and
broadcasting the packet to the other ports in the network device for use by at least one of the other ports for forwarding to a network device connected to the at least one of the other ports.

4. The method of claim 3, further comprising:
updating an ingress-side correction table for the first ingress port to include the exact destination MAC address included in the packet that was sent during the broadcasting.

5. The method of claim 1, wherein identifying a second port comprises:
converting the destination MAC address in the received packet into a received compressed destination MAC address; and
comparing the received compressed destination MAC address to the compressed destination MAC addresses in the approximate ingress table to identify a matching compressed destination MAC address in the approximate ingress table.

6. The method of claim 5, wherein the compressed destination MAC addresses in the approximate ingress table are generated using a hash function, and wherein converting the destination MAC address in the received packet comprises:
computing a hash value of the destination MAC address in the received packet through the use of the hash function.

7. The method of claim 5, wherein identifying an egress port of the network device further comprises:
comparing the destination MAC address in the received packet to one or more exact destination MAC addresses in an ingress-side correction table including one or more exact destination MAC addresses.

8. The method of claim 7, further comprising:
receiving, at the first port, a correction message from the second port; and
updating at least one of the approximate ingress table or the ingress-side correction table based on the correction message.

9. The method of claim 7, further comprising:
determining if a source MAC address in the packet is already present in the ingress-side correction table;
if the source MAC address is not present, adding the source MAC address to the ingress-side correction table; and
associating the source MAC address with the port identifier of the first port.

10. The method of claim 1, further comprising:
determining, at the second port, if the packet was broadcast from another port;
if the packet was not broadcast from another port, associating a source MAC address of the packet to the first port from where it was sourced.

11. An apparatus comprising:
a first port comprising:
a network interface configured to receive a packet comprising a destination MAC address;
memory comprising at least an approximate ingress table including a plurality of compressed destination MAC addresses each having an associated egress port; and
a processor configured to identify an egress port to which the packet should be forwarded through the use of the approximate ingress table;
a second port configured to receive the packet from the first port and comprising:
a network interface;
memory comprising an exact egress table including exact destination MAC addresses each associated with a network device connected to the network interface of the second port; and
a processor configured to identify a subsequent network device to which the packet should be forwarded, and to forward the packet to the subsequent network device via the network interface in the second port.

12. The apparatus of claim 11, wherein the processor in the first port is configured to convert the destination MAC address in the received packet into a received compressed destination MAC address, compare the received compressed destination MAC address to the compressed destination MAC addresses in the approximate ingress table to identify a matching compressed destination MAC address in the approximate ingress table, and forward the packet to an egress port associated with the matching approximate destination MAC address in the approximate ingress table.

13. The apparatus of claim 12, wherein the compressed destination MAC addresses in the approximate ingress table are generated using a hash function, and wherein the processor in the first port is configured to compute a hash value of the destination MAC address in the received packet through the use of the hash function.

14. The apparatus of claim 12, wherein the processor in the first port is configured to compare the destination MAC address in the received packet to one or more exact destination MAC addresses in an ingress-side correction table including one or more exact destination MAC addresses.

15. The apparatus of claim 14, wherein the processor of the first port is configured to receive a correction message from the second port and to update at least one of the approximate ingress table or the ingress-side correction table based on the correction message.

16. The apparatus of claim 14, wherein the processor of the first port is configured to determine if a source MAC address in the packet is already present in the ingress-side correction table and, if the source MAC address is not present, adding the source MAC address to the ingress-side correction table, and associate the source MAC address with the port identifier of the first port.

17. The apparatus of claim 14, wherein the processor of the second port is configured to determine if the packet was broadcast from another port and, if the packet was not broadcast from another port, to associate a source MAC address of the packet to the first port from where it was sourced.

18. The apparatus of claim 11, wherein the processor in the second port is configured to compare the destination MAC address in the packet to the exact destination MAC addresses in the exact egress table to identify a matching destination MAC address in the exact egress table, and forward the packet to a network device associated with the matching destination MAC address in the exact egress table.

19. The apparatus of claim 11, wherein the processor in the second port is configured to compare the destination MAC address in the packet to the exact destination MAC addresses in the exact egress table, determine that the destination MAC address in the packet does not match any destination MAC addresses in the exact egress table, and broadcast the packet to one or more other ports in the network device for use by at least one of the other ports for forwarding to a network device connected to the at least one of the other ports.

20. The apparatus of claim 19, wherein the processor in the first port is configured to update an ingress-side correction table to include the exact destination MAC address included in the packet that was sent during the broadcast.

21. One or more computer readable storage media encoded with software comprising computer executable instructions and when the software is executed operable to:
after receiving a packet comprising a destination MAC address at a first port of a network device having a plurality of bi-directional ports, identify a second port of the network device to which the packet should be forwarded through the use of at least an approximate ingress table at the first port comprising a plurality of compressed destination MAC addresses each having an associated egress port;
forward the packet to the second port;
identify a subsequent network device to which the packet should be forwarded through the use of an exact egress table at the second port including exact destination MAC addresses each associated with a network device connected to the second port; and
forward the packet to the subsequent network device.

22. The computer readable storage media of claim 21, wherein the instructions operable to identify a second port comprise instructions operable to:
convert the destination MAC address in the received packet into a received compressed destination MAC address; and
compare the received compressed destination MAC address to the compressed destination MAC addresses in the approximate ingress table to identify a matching compressed destination MAC address in the approximate ingress table.

23. The computer readable storage media of claim 22, wherein the compressed destination MAC addresses in the approximate ingress table are generated using a hash function, and wherein the instructions operable to convert the destination MAC address in the received packet comprise instructions operable to:
compute a hash value of the destination MAC address in the received packet through the use of the hash function.

24. The computer readable storage media of claim 22, wherein the instructions operable to identify an egress port of the network device further comprise instructions operable to:
compare the destination MAC address in the received packet to one or more exact destination MAC addresses in an ingress-side correction table including one or more exact destination MAC addresses.

25. The computer readable storage media of claim 21, wherein the instructions operable to identify a subsequent network device to which the received packet should be forwarded comprise instructions operable to:
compare the destination MAC address in the packet to the exact destination MAC addresses in the exact egress table to identify a matching destination MAC address in the exact egress table.

26. The computer readable storage media of claim 21, wherein the instructions operable to identify a subsequent network device to which the packet should be forwarded comprise instructions operable to:
compare the destination MAC address in the packet to the exact destination MAC addresses in the exact egress table;
determine that the destination MAC address in the packet does not match any destination MAC addresses in the exact egress table; and
broadcast the packet to the other ports in the network device for use by at least one of the other ports for forwarding to a network device connected to the at least one of the other ports.
